(19) United States
(12) Patent Application Publication
(10) Pub. No.: US 2009/0110866 A1
(43) Pub. Date: Apr. 30, 2009

(54) STRUCTURAL GLASS SYSTEM

(75) Inventors: Felix Ainz, Aro (ES); Oscar Domingo Sandin, Logrono (ES)

Correspondence Address: WOOD, HERRON & EVANS, LLP, 2700 CAREW TOWER, 441 VINE STREET, CINCINNATI, OH, 45202, US

(73) Assignee: GLASS XXI, S.A., Miranda de Ebro (ES)

(21) Appl. No.: 12/062,190

(22) Filed: Apr. 3, 2008

Related U.S. Application Data
(60) Provisional application No. 60/983,765, filed on Oct. 30, 2007.

(51) Int. Cl. B32B 3/10; B32B 3/00; C03C 27/00

(52) U.S. Cl. 428/53; 428/131; 156/104

(57) ABSTRACT

A glass assembly for use in a structural glass system includes a glass panel having a top surface, and a sacrificial glass layer removably secured to the top surface. The glass panel may be formed from plural layers of laminated glass. A sealing layer is disposed between the top surface and the sacrificial glass layer to define a chamber therebetween. The glass assembly further includes a valve providing fluid communication between the chamber and the environment to facilitate evacuating fluid from the chamber.

The present application claims the filing benefit of co-pending U.S. Provisional Patent Application No. 60/983,765, filed Oct. 30, 2007 (now pending), the disclosure of which is incorporated by reference herein in its entirety.

### TECHNICAL FIELD

The present invention relates generally to building structures, and more particularly to a structural glass system for use in building structures.

### BACKGROUND

Glass has been used in various structural applications for aesthetic or functional purposes. For example, structural glass has been used in floors, walls, ceilings, roofs, and various other structures for both indoor and outdoor applications. The structural glass may be transparent or translucent, and may include various decorative features such as coloring, photographs, drawings, or other aesthetically pleasing features. Such structural glass is conventionally formed as a laminate of multiple layers of glass sheet that are bonded together using Polyvinyl Butyral (PVB) or other suitable material. Once the glass sheets are joined together, they are virtually impossible to separate.

In use, the surfaces of a structure made with structural glass may become scratched, chipped, or otherwise damaged or degraded such that it is desired to replace the structural glass components. In conventional glass systems, however, this requires replacement of the entire glass panel, including the interior layers of the laminate which are generally not damaged or degraded. Replacement of such glass panels is difficult due to their size and weight. Moreover, the need to remove the entire panel leaves one or more spaces in the structure which much be covered or avoided, thereby making the structure unusable until the removed panels are replaced. A need therefore exits for a structural glass system that overcomes these and other drawbacks of conventional structural glass systems.

### SUMMARY

The present invention overcomes the foregoing and other shortcomings and drawbacks of glass assemblies heretofore known for use in structural glass applications. While the invention will be described in connection with certain embodiments, it will be understood that the invention is not limited to these embodiments. On the contrary, the invention includes all alternatives, modifications and equivalents as may be included within the spirit and scope of the present invention.

In one aspect, a glass assembly for use in a structural glass system includes a glass panel having a top surface, and a sacrificial glass layer removably secured to the top surface. The glass panel may comprise plural layers of laminated glass. A sealing layer is disposed between the top surface and the sacrificial glass layer to define a chamber therebetween. An aperture through the sacrificial glass layer communicates with the chamber. A valve is coupled to the aperture and has an open condition wherein fluid may pass through the valve into or out of the chamber, and a closed condition wherein fluid is prevented from passing through the valve.

In another aspect, a glass floor system includes a plurality of glass assemblies, as described above, and a support structure. The support structure includes at least one surface that engages peripheral edges of the glass assemblies.

In yet another aspect, a method of making a glass assembly includes placing a sacrificial glass layer in registration with a top surface of a glass panel and sealing the sacrificial glass layer to the glass panel to define a chamber therebetween. Gas is evacuated from the chamber and the chamber is sealed. The method may further include removing a surface layer that is originally disposed on the glass panel.

These and other features, objects and advantages of the invention will become more readily apparent to those skilled in the art in view of the following detailed description, taken in conjunction with the accompanying drawings.

### BRIEF DESCRIPTION OF THE FIGURES

FIG. 1 is a plan view of an exemplary glass assembly for use in a structural glass system, in accordance with the principles of the present disclosure.

FIG. 2 is a partial cross-sectional view of the exemplary glass assembly of FIG. 1, taken along line 2-2.

FIG. 3 depicts the glass assembly of FIG. 2. during evacuation of a chamber of the glass assembly.

FIG. 4 depicts the glass assembly of FIG. 2 with a valve shown in a closed condition.

FIG. 5 is a partial perspective view of an exemplary glass floor system including glass assemblies as shown in FIG. 1.

FIG. 6 is a partial perspective view of another exemplary glass floor system including glass assemblies of FIG. 1.

FIG. 7 is a partial cross-sectional view of the glass floor system of FIG. 5, taken along line 7-7.

FIG. 8 is a partially exploded view of the cross-section shown in FIG. 7.

FIG. 9 is a perspective view of illustrating an exemplary tool and method for assembling a glass assembly.

FIG. 10 is a perspective view similar to FIG. 9, depicting a sacrificial glass layer positioned on a glass panel.

FIG. 11 is a perspective view of illustrating another exemplary tool and method for assembling a glass assembly.

FIG. 12 is a perspective view similar to FIG. 11, depicting a sacrificial glass layer being positioned on a glass panel.

### DETAILED DESCRIPTION

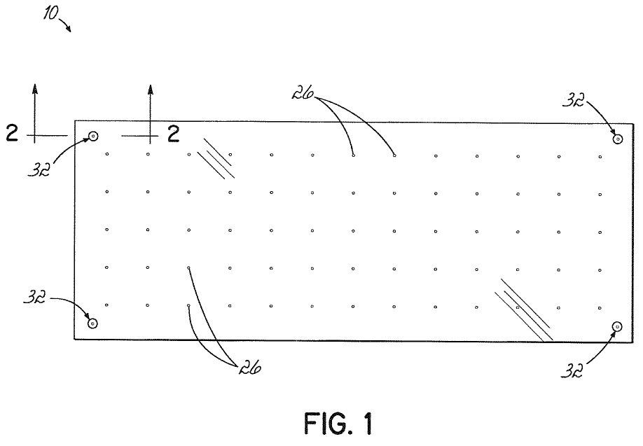

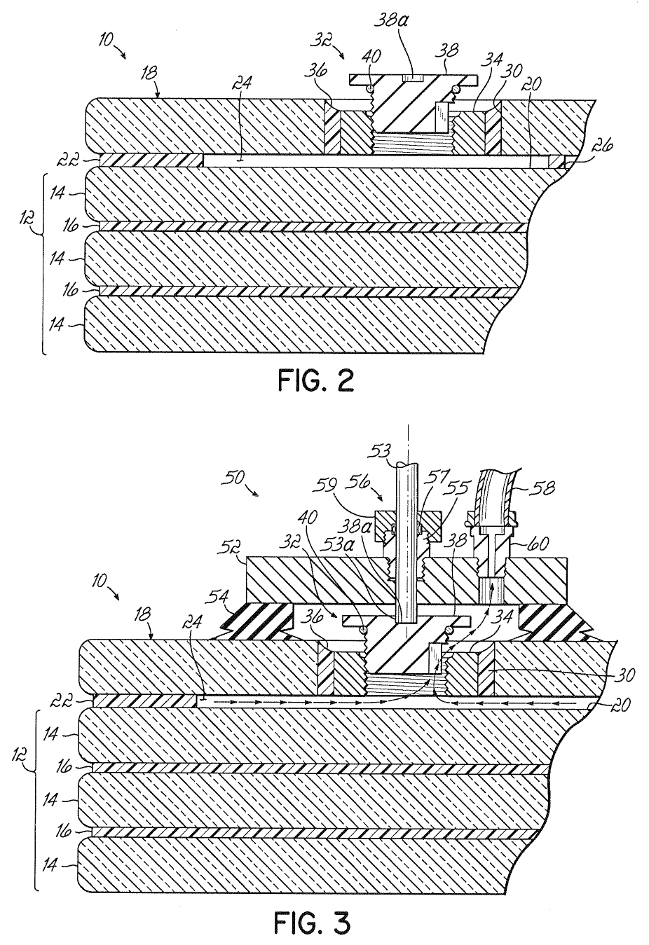

FIGS. 1-2 depict an exemplary glass assembly 10 in accordance with the principles of the present disclosure. In the embodiment shown, the glass assembly 10 includes a laminated glass panel 12 made up of several layers of glass 14 joined to one another by layers of Polyvinyl Butyral (PVB) 16 or other suitable material. While the embodiment shown depicts only three glass layers 14, it will be appreciated that the glass panel 12 may comprise fewer glass layers 14, or a greater number of glass layers 14, as may be desired for a particular application. Moreover, the glass layers 14 may have varying thicknesses and may be provided in various colors, or may be transparent or translucent, as may be desired to suit a particular application. The edges of the glass layers 14 are generally ground to remove sharp corners.

The glass assembly 10 further includes a sacrificial glass layer 18 positioned above a top surface 20 of the glass panel 12 and aligned for registration with the edges of the glass panel 12. A layer of sealing material 22 is disposed between the top surface 20 of the glass panel 12 and the sacrificial glass layer 18, generally around the peripheral border of the glass panel 12, to removably seal sacrificial glass layer 18 to top surface 20. In the embodiment shown, the sealing material 22 is acrylic foam tape, but it will be appreciated that various other materials suitable for sealing the sacrificial glass layer 18 to the glass panel 12 may alternatively be used. The sacrificial glass layer 18 is spaced from the top surface 20 of the glass panel 12 by the sealing material 22 to define an interior chamber 24.

The glass assembly 10 may further include one or more inserts 26 within chamber 24 and disposed between the top surface 20 of glass panel 12 and the sacrificial glass layer 18. The inserts 26 help to support the sacrificial glass layer 18 against bending out of the plane of the sacrificial glass layer 18 so as to reduce or eliminate an optical effect caused by an interference of reflected light, generally known as “Newton's rings”. In the embodiment shown, the inserts 26 have a generally circular cross-sectional shape and are formed from transparent vinyl material. The inserts 26 are approximately 5 mm in diameter and about 0.2 mm thick, and are uniformly positioned across the top surface 20 with a separation of about 100 mm between inserts 26. It will be appreciated that various other materials may be disposed between the sacrificial glass layer 18 and the glass panel 12, and may be provided in various configurations. In some embodiments it may be desired that such insert materials be colored or formed in various designs or patterns to provide an aesthetically pleasing appearance to the glass assembly 10. As non-limiting examples, such insert materials may include textile screens, photographs, special papers, or other materials. Such materials may be used to provide decorative appearance as well as to reduce or eliminate the Newton ring effect.

With continued reference to FIGS. 1-2, the sacrificial glass layer 18 includes at least one aperture 30 therethrough and in communication with the chamber 24. A valve 32 is disposed in the aperture 30 and is selectively adjustable between an open condition that permits air or other fluids to be withdrawn from or admitted into the chamber 24, and a closed condition that prevents the passage of fluids through the aperture 30. In the embodiment shown, the valve 32 comprises a fitting 34 secured within the aperture 30 by a suitable adhesive 36, and a plug 38. The fitting 34 and plug 38 are provided with corresponding threaded portions to permit the plug 38 to be threadably advanced into the fitting 34 to engage a seal ring 40 with the fitting 34, thereby tightly sealing the chamber 24. It will be appreciated that various other types of valves or other structure suitable for selectively sealing the interior chamber 24 may alternatively be used. These other types of valves or other structure need not necessarily be provided in the sacrificial glass layer 18, so long as they are able to provide fluid communication with chamber 24 and are able to seal the chamber 24.

In the embodiment shown, aperture 30 and valve 32 are located adjacent a peripheral edge of sacrificial glass layer 18 so that the aperture 30 and valve 32 may be hidden from view by trim or frame members used to support the glass assembly 10, thereby providing an aesthetically clean appearance. FIG. 1 depicts a glass assembly 10 having four apertures 30 and corresponding valves 32, one positioned near each corner of the glass assembly 10. It will be appreciated, however, that glass assemblies 10 may alternatively have only a single aperture and valve 30, 32, or may have a greater number of apertures and valves 30, 32.

FIG. 3 depicts the interior chamber 24 of the glass assembly 10 being evacuated using a vacuum fixture 50. Removing air from the chamber 24 reduces or eliminates the possibility that condensation will form on the top surface 20 or the surface of the sacrificial glass layer 18 that defines the chamber 24. Such condensation would likely detract from the aesthetics of the glass assembly 10. The vacuum fixture 50 includes a plate 52 and a sealing element 54 adapted to engage the outer surface of the sacrificial glass layer 18. A valve engagement tool 56 includes a shaft 53 that extends through the plate 52 and allows an operator to selectively open and close the valve 32 when the vacuum fixture 50 is placed over the aperture 30. In the embodiment shown, shaft 53 is rotatably coupled to plate 52 by a bushing 55 that is threadably secured to plate 52. A shaft seal 57 is disposed between the bushing 55 and a cap 59 and seals against the shaft 53 to prevent air from entering chamber 24 along the shaft 53. A distal end 53a of the shaft 53 operatively engages the plug 38 to facilitate turning the plug 38 and thereby selectively open and close the valve 32. For example, the distal end 53a of the shaft 53 may be shaped to engage a complementary recess 38a in the plug 38, such as a hex socket or other structure, so that plug 38 may be threadably advanced or withdrawn from fitting 34.

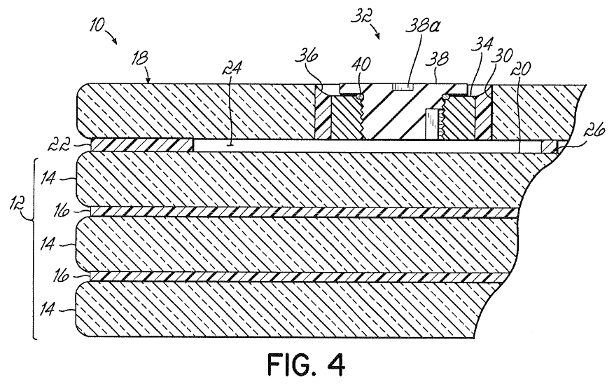

When the valve 32 is in the open condition, with seal ring 40 spaced from fitting 34 as depicted in FIG. 3, air may be evacuated through a vacuum hose 58 coupled to the plate 52 by a hose fitting 60. Air is drawn from the chamber 24 through the valve 32, then the valve 32 is moved to the closed condition (FIG. 4) using the valve engagement tool 56 such that the chamber 24 is sealed under vacuum. With the valve 32 securely sealed, the vacuum fixture 50 may be withdrawn, as depicted in FIG. 4.

The completed glass assembly 10 may be assembled together with other glass assemblies 10 to form various structural systems, such as floors, walls, ceilings, roofs, or other structures. If the sacrificial glass layer 18 becomes scuffed, scratched, or otherwise damaged or degraded, the sacrificial glass layer 18 may be removed from the glass assembly 10 and replaced with another sacrificial glass layer 18. The entire glass assembly 10 does not have to be removed from the structure, as was necessary with conventional structural glass systems, thereby providing an efficient, cost effective alternative to replacement of conventional glass assemblies. To remove the sacrificial glass layer 18, at least one of the valves 32 is placed in the open condition release the vacuum pressure and to allow air to enter the chamber 24. Thereafter, the seal 22 may be broken and the sacrificial glass layer 18 removed from the top surface 20 of the glass panel 12. An exemplary tool and method for removing sacrificial glass layer 18 is described below. A new sacrificial glass layer 18 may then be positioned over top surface 20 and sealed to top surface 20 to create interior chamber 24, as described above. The sealed chamber 24 may then be evacuated, as described above.

While the embodiments shown and described herein depict glass assemblies 10 with a sacrificial glass layer 18 provided on one side of glass panel 12, it will be appreciated that glass assemblies 10 may alternatively include sacrificial glass layers 18 provided on both sides of glass panel 12. Such an arrangement might be desired in certain structural systems wherein both sides of a glass assembly 10 are exposed to conditions that might damage or degrade the surfaces of the glass assembly 10, such as a wall formed from structural glass.

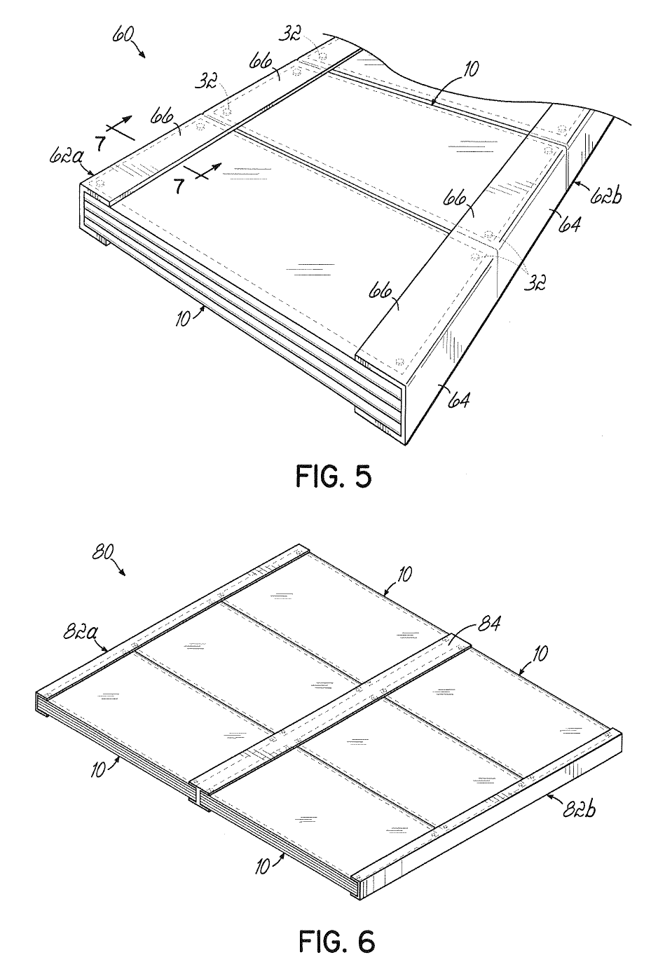

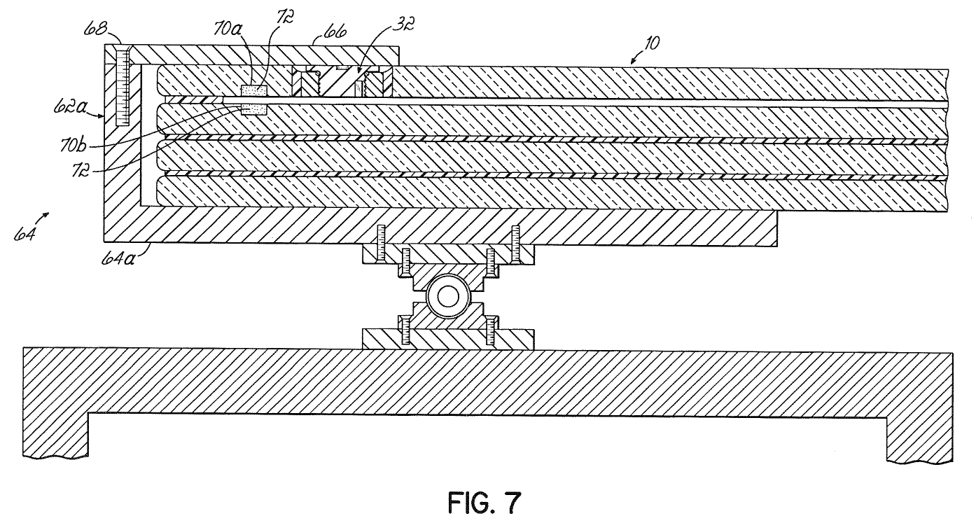

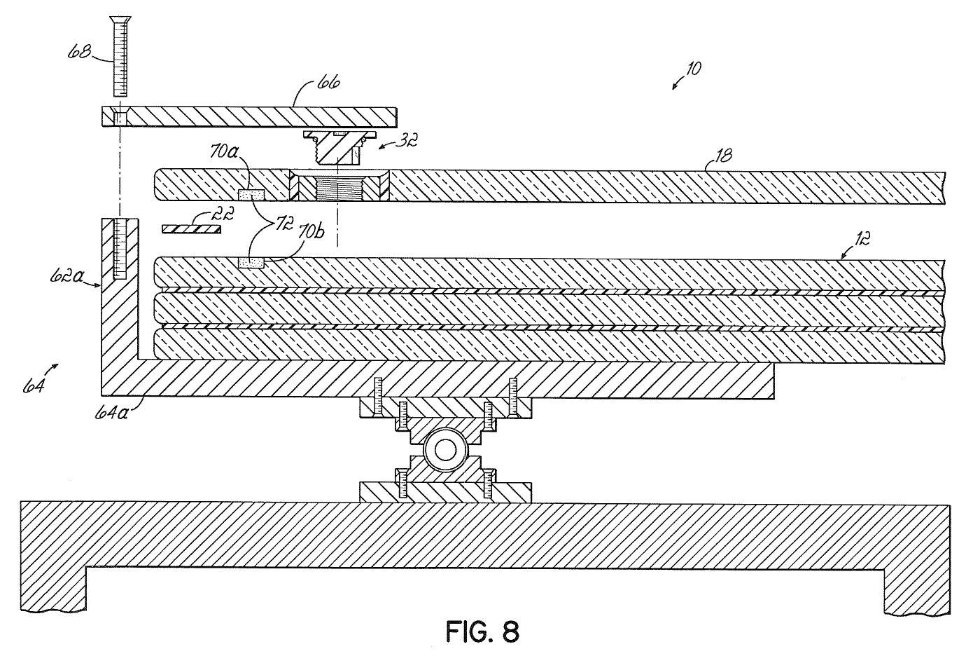

FIG. 5 depicts an exemplary glass floor system 60, in the form of a bridge or walkway, including glass assemblies 10 positioned adjacent one another in an edge-to-edge arrangement. Opposite transverse edges of the glass assemblies 10 are engaged by supporting structure in the form of beam sections 62a, 62b as shown in FIGS. 7-8. In the embodiment shown, each beam section 62a, 62b includes at least an L-shaped portion 64 having a lip 64a in which the glass assemblies 10 are received, and a top plate 66 that is coupled to the L-shaped portion 64, such as by a fastener 68, to secure the glass assemblies 10 in place. The glass assemblies 10 may be constructed generally as described above, with valves 32 provided in locations that will be covered by top plates 66 and thereby hidden from view, to provide an aesthetically pleasing appearance to the glass floor system 60.

The glass assemblies 10 may further include a recess 70a, 70b formed in either the sacrificial layer 18, the top surface 20 of the glass panel 12, or both, as depicted in FIG. 7. A desiccant 72, such as zeolite or any other material suitable for removing moisture from chamber 24, may be provided in the recesses 70a, 70b to remove any moisture that may be in the chamber 24. In the embodiment shown, the recesses 70a, 70b are located at positions that will be hidden from view by the top plate 66.

FIG. 6 depicts another exemplary glass floor system 80 including glass assemblies 10 positioned adjacent one another in an edge-to-edge arrangement to create a relatively wide span of floor. In this embodiment, edges of the glass assemblies 10 are received in support structure that includes generally C-shaped beam members 82a, 82b and I-shaped beam members 84. The beam members 82a, 82b, and 84 may include portions that extend over valves 32 and recesses 70a, 70b which may be provided on glass assemblies 10, in a manner similar to that described above.

FIGS. 5-8 depict only two exemplary embodiments of support structure that could be used to support glass assemblies 10 in a glass floor system. It will be appreciated that various other configurations of support structure may alternatively be used. It will also be appreciated that glass assemblies 10 are not limited to use in a glass floor system, but may also be used to form walls, ceilings, roofs, or various other structural systems.

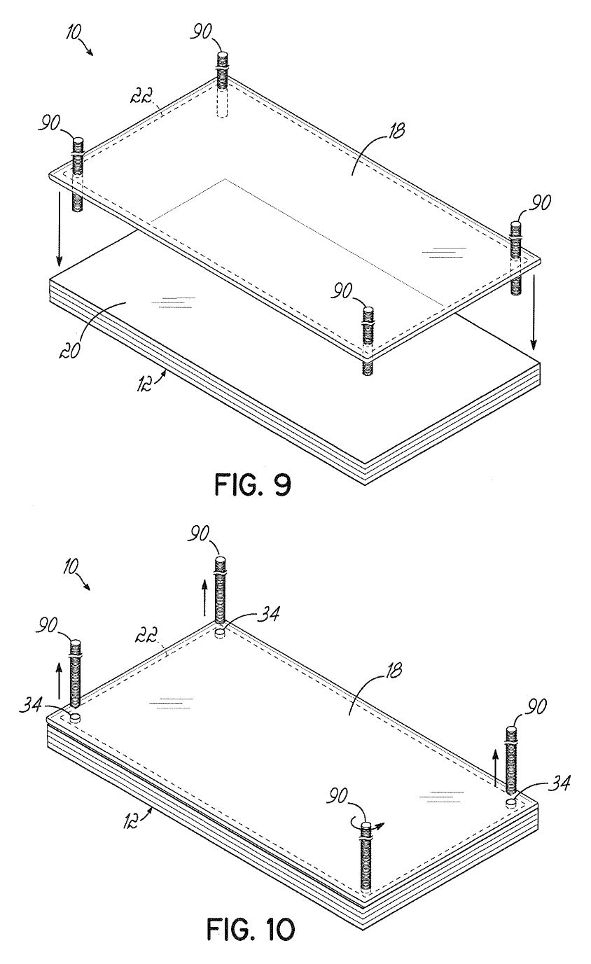

FIGS. 9 and 10 illustrate an exemplary method and tool for installing a sacrificial glass layer 18 to a glass panel 12 to form a glass assembly 10 as discussed above. In the embodiments shown, threaded rods 90 are engaged with corresponding threaded portions of valve fittings 34 located at respective corners of the sacrificial glass layer 18. The threaded rods 90 may then be used to located the sacrificial glass layer 18 in the desired position in registration with the glass panel 12. If sealing material 22 is provided in the form of an adhesive tape with a backing layer, the backing layer may be removed and the sacrificial glass layer 18 lowered into the desired position on top surface 20. The threaded rods 90 may thereafter be removed from the fittings 34 and the chamber 24 may be evacuated as discussed above.

Threaded rods 90 may also be used to remove the sacrificial glass layer 18 from the top surface 20 of glass panel 12. To remove the sacrificial glass layer 18, valves 32 are placed in the open condition to admit air into the chamber 24. Plugs 38 are removed and rods 90 are threadably engaged with the fittings 34. Lifting forces are applied to the rods 90 to facilitate separating the sacrificial glass layer 18 from the top surface 20.

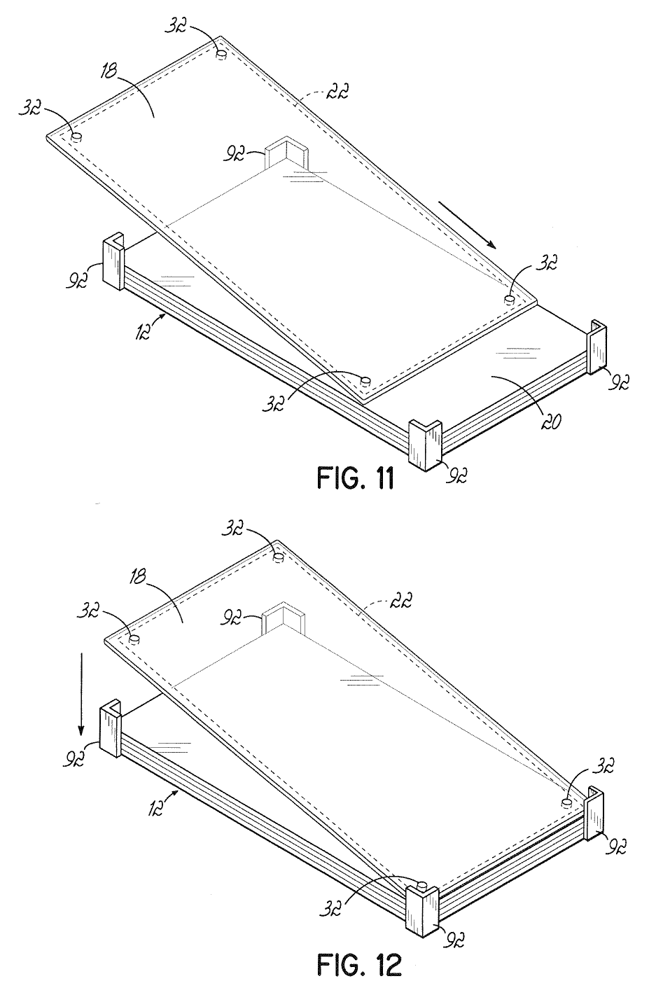

FIGS. 11 and 12 depict another exemplary method and tool for installing a sacrificial glass layer 18 to the top surface 20 of a glass panel 12 to form a glass assembly 10. In this embodiment, angle-shaped guides 92 are used to locate the sacrificial glass layer 18 in registration with the glass panel 12. The threaded rods 90 may be used with the guides 92, in a manner similar to that discussed above, to facilitate locating and placing the sacrificial glass layer 18 in the desired position. After the sacrificial glass layer 18 is properly positioned, guides 92 may be removed.

While the present invention has been illustrated by the description of exemplary embodiments thereof, and while the embodiments have been described in considerable detail, they are not intended to restrict or in any way limit the scope of the appended claims to such detail. Additional advantages and modifications will readily appear to those skilled in the art. The various features disclosed herein may be used alone or in any desired combination. The invention in its broader aspects is therefore not limited to the specific details, representative apparatus and method and illustrative examples shown and described. Accordingly, departures may be made from such details without departing from the scope or spirit of the general inventive concept.

What is claimed is:

1. A glass assembly for use in a structural glass system, the glass assembly comprising:
a glass panel having a top surface;
a sacrificial glass layer removably secured to said top surface of said glass panel;
a sealing layer disposed between said top surface and said sacrificial glass layer and defining a chamber between said top surface and said sacrificial glass layer;
an aperture through said sacrificial glass layer and communicating with said chamber; and
a valve operatively coupled to said aperture, said valve having an open condition wherein fluid may pass through valve, and a closed condition wherein fluid is prevented from passing through said valve.

2. The glass assembly of claim 1, wherein said glass panel comprises plural layers of laminated glass.

3. The glass assembly of claim 1, further comprising:
at least one insert disposed in said chamber.

4. The glass assembly of claim 1, further comprising:
a desiccant disposed in said chamber.

5. The glass assembly of claim 4, further comprising:
a recess formed in at least one of said top surface or said sacrificial layer and communicating with said chamber;
said desiccant disposed within said recess.

6. A glass floor system, comprising:
a plurality of glass assemblies, each glass assembly including a peripheral edge and comprising:
a glass panel having a top surface,
a sacrificial glass layer removably secured to said top surface of said glass panel,
a sealing layer disposed between said top surface and said sacrificial glass layer and defining a chamber between said top surface and said sacrificial glass layer, and
a valve providing fluid communication between said chamber and the environment, said valve having an open condition wherein fluid may pass through said valve, and a closed condition wherein fluid is prevented from passing through said valve; and
a support structure including at least one surface engaging said respective peripheral edges of said glass assemblies.

7. The glass floor system of claim 6, further comprising:
an aperture through said sacrificial glass layer and communicating with said chamber;
said valve operatively coupled to said aperture.

8. The glass floor system of claim 6, wherein said support structure is positioned to hide said valve from being viewed from a location above said sacrificial glass layer.

9. The glass floor system of claim 6, further comprising:
at least one insert disposed in said chamber.

10. The glass floor system of claim 6, further comprising:
a recess formed in at least one of said top surface or said sacrificial layer and communicating with said chamber;
said desiccant disposed within said recess.

11. A glass assembly for use in a structural glass system, the glass assembly comprising:
a glass panel having a top surface;
a sacrificial glass layer removably secured to said top surface of said glass panel;
a sealing layer disposed between said top surface and said sacrificial glass layer and defining a chamber between said top surface and said sacrificial glass layer; and
a valve providing fluid communication between said chamber and the environment, said valve having an open condition wherein fluid may pass through said valve, and a closed condition wherein fluid is prevented from passing through said valve.

12. A method of making a glass assembly, the method comprising:
placing a sacrificial glass layer in registration with a top surface of a glass panel;
sealing the sacrificial glass layer to said top surface to define an interior chamber between the top surface and the sacrificial glass layer;
evacuating fluid from the interior chamber; and
sealing the interior chamber.

13. The method of claim 12, further comprising:
placing a desiccant in the interior chamber.

14. The method of claim 12, further comprising:
removing a surface layer originally disposed on the glass panel.

15. The method of claim 12, further comprising:
locating the sacrificial glass layer in registration with the top surface using a rod coupled to the aperture; and
removing the rod from the aperture.

16. The method of claim 12, further comprising:
locating the sacrificial glass layer in registration with the top surface using a guide adapted to engage at least a portion of a peripheral edge of the glass panel.
